(19) United States
(12) Patent Application Publication
(10) Pub. No.: US 2010/0050484 A1
(43) Pub. Date: Mar. 4, 2010

(54) Insignia device

(76) Inventor: Scott M. Joffe, Austin, TX (US)

Correspondence Address: DOUGLAS E. WARREN;ATTORNEY AT LAW, P.O. BOX 6727, CHESTERFIELD, MO, 63006, US

(21) Appl. No.: 12/583,261

(22) Filed: Aug. 18, 2009

Related U.S. Application Data
(63) Continuation-in-part of application No. 12/228,596, filed on Aug. 14, 2008.

(51) Int. Cl. G09F 19/00; B32B 38/00

(52) U.S. Cl. 40/1; 156/150

(57) ABSTRACT

The present invention relates to an insignia device that incorporates a set of indicia that has been manufactured using an electrodeposition/electroforming process. The set of indicia can include business letterheads, personal letterheads, logos, pictorial graphics, text, images, communicating marks, or illustrative marks where the set of indicia has been mounted on a mounting service.

### CROSS REFERENCE TO RELATED APPLICATIONS

This is a continuation-in-part application that claims the benefit of all applicable priority from Nonprovisional application Ser. No. 12/228,596 filed on Aug. 14, 2008, and that application is incorporated by reference herein in its entirety for all purposes.

### STATEMENT REGARDING FEDERALLY SPONSORED RESEARCH

Not Applicable.

### BACKGROUND OF THE INVENTION

There are many social, religious, and business occasions where business and personal communications are prepared and sent to various individuals and entities. For example, wedding invitations are usually sent to the friends of the bride and groom to signal the time and date of a wedding. In other instances, communications are sent to potential guests for social and religious events such as birthdays, holidays, and the announcement of births within a family. In yet other instances, both social and business, formal correspondence is desired in order for the sender to convey a heightened sense of creativity, style, or importance.

In the business world there are also a number of business activities that often indicate the use of insignias as logos, etc. For example, general business communications, the formation of a new business, the relocation of an existing business, the notice that a new partner has joined a firm, or even the announcement that a new product is being introduced into a new market are events for which communications usually used.

In each of the above events, whether family, social, religious, or business, there is normally a desire to send a communication that is unique and special in appearance and content. In the past, such communications have included the use of formal engraved lettering, high quality printing processes, letterpresses, embossing, and debossing that can be placed upon special high quality paper. In other instances, the use of metal foil as the medium has been used to generate decorative, formal, and festive types of communications. In yet other instances, cards and papers having special cutouts and folds are often used to generate attractive and unusual forms of communications that are interesting to read and which denote the proper amount of emotion to be evoked by the communication.

Although business, social, and family communications usually involve the use of greeting cards, there are other occasions where alternative types of devices are often used as communication devices. For example, when businesses wish to communicate specific types of information about their products or services, businesses can provide calendars, business cards, and other types of marketing material. In other circumstances regarding such activities as charitable events or award ceremonies, the communication and even the actual certificates of award, are generally made in a manner that is out of the ordinary and that have special appearance attributes—with the more unusual appearance attributes being the most preferable. As in the case of the communications noted above, those other types of communication devices can also include the use of materials, paper, and graphics that are eye-catching and attractive.

Thus, in virtually every type of instance where a communication of some type is prepared, it is important to generate a communication that is unique, interesting, attractive, and in tune with the communication being made.

One widely used method of making a communication special is to include a unique insignia on the surface of the communication device. When the communication is business related, the insignia may be a logo. When the communication is personal, the insignia may be a stylized form of the initials of the communicator. In yet other types of communications, the insignia may be a graphic image that relates to either the communicator, the subject matter of the communication, a particular phrase, a portion of text, or simply something that the communicator wishes to include on the communication.

### SUMMARY OF THE INVENTION

The various embodiments of the present invention include configurations of a unique, interesting, and attractive insignia device that takes a product made for an unrelated specific purpose and then uses that insignia in a manner that is both new, unexpected, and unusual.

More specifically, preferred embodiments of the present invention of an insignia device comprise insignias generally formed as script, graphics, symbols, letters from the alphabet, numbers, or any other type of indicia that are then applied to mounting surfaces commonly used in the generation of business, personal, or social communications, wherein the insignias are generally manufactured using a metallic electrodeposition (also known as “electroforming”) process.

Metal electrodeposition is a well-known art that involves depositing metallic molecules onto another surface. There are a number of previously issued United States patents that address such techniques. For example, U.S. Pat. No. 924,420 discloses the general electrodeposition process that is old in the art. Additionally, U.S. Pat. No. 4,620,903 discloses an electroforming process that includes a method for producing highly detailed and multi-relief nameplates. That patent discloses a process by which a master image is produced by photo etching with a photopolymer. A negative production tool is formed from this master image, and comprises a plurality of individual products formed in a sheet. Finally, U.S. Pat. No. 4,462,873 discloses a method of fixedly arranging an array of electroformed letters to a surface. It is noted that the contents of U.S. Pat. Nos. 924,420 and 4,620,903 and 4,462,873 are hereby incorporated by reference as if fully stated herein.

Various types of electrodeposition and electroforming processes are disclosed in each of those patents. Some of those electrodeposition processes can be used to manufacture items such as automotive emblems to be placed upon the body of automotive vehicles. Examples this use would include the “bow tie” emblem used on cars and trucks made by the Chevrolet Division of the General Motors Corporation, as well as the emblem “CORVETTE” that is also placed on the side of those same Chevrolet sports cars.

The present invention uses the art of electrodeposition to produce insignias that incorporate not only extremely high quality metallic lettering, but also pictorial graphics, images, logos, etc. that can be placed on a surface of a medium or substrate. The result is a new, unexpected, and exceptionally unique insignia that is particularly attractive and that conveys the style of the sender or the special importance of the event identified within the communication. This is to say, the present invention takes products similar to those that are normally made to be placed on cars and trucks, and instead places those products on various types of communications as highly unique insignias for use on any type of communication device that can include, for example and without limitation, business letterheads, personal letterhead, general stationery, greeting cards, invitations, and the like. This use of those unique insignias in such an uncommon and unexpected manner results in the new and distinctive embodiments of the present invention.

### DESCRIPTION OF THE DRAWINGS

In the accompanying drawings which form part of the specification:

FIG. 1 is a front perspective view of one embodiment of the present invention; and,

FIG. 2 is a section view of one embodiment of the present invention showing certain elements of one embodiment of the present invention as well as some of the components used in the process of manufacturing that embodiment.

Corresponding reference characters indicate corresponding parts throughout the several views of the drawings.

While embodiments of the present invention are illustrated in the above referenced drawings and in the following descriptions, it is understood that the embodiments shown are merely for purpose of illustration and that various changes in construction may be resorted to in the course of manufacture in order that the present invention may be utilized to fit the circumstances which may arise, without in any way departing from the spirit and intention of the present invention, which is to be limited only in accordance with the claims contained herein.

### DETAILED DESCRIPTION OF ONE PREFERRED EMBODIMENT

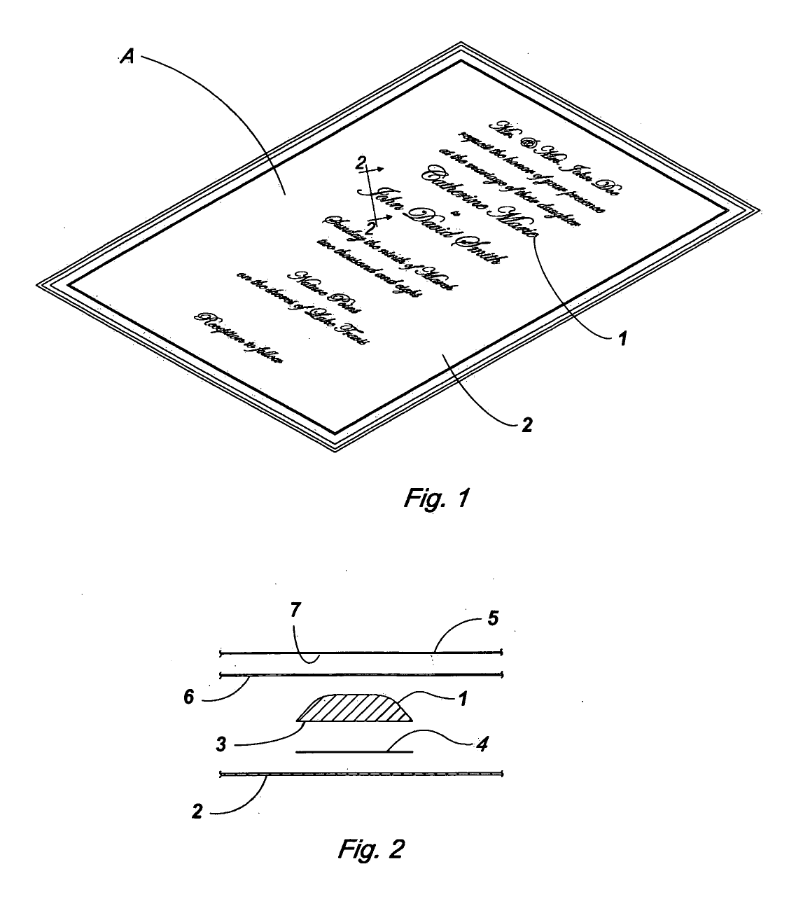

Referring now to FIG. 1, the present invention relates to an insignia device A, and more specifically to an insignia device that comprises a set of indicia 1 that has been placed on a mounting surface 2. The indicia 1 can be any type of text, image, graphic, or other communicating or illustrative mark that is generally made using the process of electrodeposition or electroforming. The mounting surface 2 can be of any type material as long as the mounting surface is capable of allowing the set of indicia 1 to be properly mounted onto the mounting surface. For example, the mounting surface can be made of paper, cardstock, plastic stock, wood stock, metal, or leather.

It is understood that the set of marking indicia 1 has pertinent information related to at least one of either a business logo, a trademark, a person's initials and/or contact information, a wedding, a social event, a religious event, a business event, or a family event, or any general communication, piece of information, or graphic, any of which can be selected as necessary for the particular application. Depending upon the alternative embodiment of the present invention that is used, exemplary information in the set of indicia 1 may include wedding invitations that are usually sent to the friends of the bride and groom to signal the time and date of a wedding. In other instances, communications upon which the insignia device A mounted are sent to potential guests for social and religious events such as birthdays, holidays, and the announcement of births within a family.

In yet other alternative embodiments of the present invention, the set of indicia 1 can include information related to business events such as the formation of a new business, the relocation of an existing business, the notice that a new partner has joined a firm, or even the announcement that a new product is being introduced into a new market, all of which are events for which communications and greeting cards can, and are, usually used. The insignia device A can be included in each of these alternative embodiments.

In yet other embodiments, the entire set of communications placed on the mounting surface may include insignias that have been made by the electroforming process. FIG. 1 illustrates such an example where the entire text of the communication includes insignia made in that manner.

In the present embodiment, the insignia device A comprising the set of indicia 1 is mounted to the mounting surface 2 as shown in FIG. 2. The indicia 1 has a back surface 3. A first adhesive 4 is applied to the back surface 3 to allow the indicia 1 to be applied to the mounting surface 2.

In a preferred embodiment, the process of mounting the set of indicia 1 involves the use of the first adhesive 4 disposed on the back surface 3 of the set of indicia and a fixation sheet 5 having a layer of a second adhesive 6 on a reverse surface 7 of the fixation sheet. In this embodiment, the fixation sheet 5 is made from a generally translucent material such as acetate. However, it is understood that other materials may also be used for the fixation sheet 5. For example, plastic, Mylar®, glass, or any other similar material may also be used for the fixation sheet 5 of the present embodiment as long as the material selected is sufficiently translucent to allow for the proper alignment of the set of indicia 1 onto the mounting surface 2 and is receptive to the application of the second adhesive 6 to the fixation sheet.

It will be appreciated that in alternative embodiments the fixation sheet 5 need not be translucent or clear when the process of aligning the set of indicia 1 onto the mounting surface 2 does not require the ability to see the set of indicia as it is mounted onto the mounting surface. For example, in substantially automated manufacture of one embodiment of the present invention, the fixation sheet 5 need not be clear or translucent when other mechanisms are used to properly align the fixation sheet with the mounting surface 2. In such situations, mechanical stops, optical alignment tools, or other such devices may be used to sufficiently align the fixation sheet 5 with the mounting surface 2 to ensure proper alignment of the set of indicia 1 onto the mounting surface.

It is understood that the gripping power of the first adhesive 4 on the set of indicia 1 is stronger than the adhesive grip of the layer of second adhesive 6 on the reverse surface 7 of the fixation sheet 5. Thus, after the set of indicia 1 has been manufactured by an electrodeposition process generally similar to that as described in U.S. Pat. No. 4,462,873, the mounting surface 5 is selected as dictated by any particular application of the present invention. It is understood that while the electroforming process from U.S. Pat. No. 4,462,873 is preferred in the present embodiment, in yet other embodiments of the present invention other types of electroforming of the set of indicia 1 may also be used while still remaining within the intended scope of the present invention. It is also understood that the term electrodeposition as used herein is intended to include the process of electroforming.

After the generation of the set of indicia 1, the fixation sheet 5 is aligned as needed on the mounting surface 2 and the fixation sheet, with the set of indicia beneath it, are pressed onto the mounting surface. After it is confirmed that the set of indicia 1 has been adequately affixed to the mounting surface 2, the fixation sheet 5 is removed from the set of indicia. Because the gripping power of the adhesive 4 on the set of indicia 1 is stronger than the adhesive grip of the layer of adhesive 6 on the reverse surface 7 of the fixation sheet 5, the adhesive 6 releases its grip on the set of indicia to allow the fixation sheet 5 to be removed from the set of indicia without removal of the set of indicia from the mounting surface 2.

This process results in a unique type of insignia that does not use the normal ink or thin layer of metallic foil typically used on for such items, but which instead uses metallic electrodeposition-type indicia most commonly used as emblems and the like for the exterior bodies of automobiles.

While the above description describes various embodiments of the present invention, it will be clear that the present invention may be otherwise easily adapted to fit any configuration where an insignia device is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. An insignia device comprising:
a set of indicia manufactured using an electrodeposition process;
an adhesive applied to a back surface of the set of indicia; and
a mounting surface upon which the set of indicia is mounted to make a communication device.

2. The insignia device of claim 1 wherein the set of indicia includes at least one of either pictorial graphics, text, images, communicating marks, or illustrative marks.

3. The insignia device of claim 2 wherein the mounting surface is made from a material selected from the group consisting of paper, cardstock, plastic stock, wood stock, metal, leather, and any other type of material that is capable of allowing the set of indicia to be properly mounted onto a mounting surface.

4. An insignia device comprising:
a set of indicia that includes at least one of either pictorial graphics, text, images, communicating marks, or illustrative marks, and wherein the set of indicia is generally metallic in appearance and is manufactured using an electrodeposition process;
an adhesive applied to a back surface of the set of indicia; and
a mounting surface upon which the set of indicia is mounted to make a communication device.

5. The insignia device of claim 4 wherein the mounting surface is made from a material selected from the group consisting of paper, cardstock, plastic stock, wood stock, metal, leather, and any other type of material that is capable of allowing the set of indicia to be properly mounted onto a mounting surface.

6. The process of manufacturing an insignia device comprising the steps of:
manufacturing a set of indicia using an electrodeposition process;
applying a first adhesive to a back surface of the set of indicia;
applying a second adhesive to a reverse surface of a fixation sheet;
mounting the fixation sheet to the set of indicia by attaching the second adhesive of the fixation sheet to an upper surface of the set of indicia to affix the fixation sheet to the set of indicia;
aligning the set of indicia with a mounting surface;
disposing the set of indicia onto the mounting surface; and
removing the fixation sheet from the set of indicia to make a communication device.

7. The process of manufacturing an insignia device in accordance with the process of claim 6 wherein the step of applying a second adhesive onto the reverse surface of the fixation sheet includes using a first adhesive has less gripping power than the second adhesive.

8. The process of manufacturing an insignia device in accordance with process of claim 7 wherein the step of mounting the fixation sheet to the set of indicia includes the mounting of a fixation sheet that is one of either generally clear or generally translucent.

9. The process of manufacturing an insignia device in accordance with the process of claim 8 wherein the step of manufacturing a set of indicia using an electrodeposition process includes the manufacturing of a set of indicia that includes at least one of either pictorial graphics, text, images, communicating marks, or illustrative marks.

10. The process of manufacturing an insignia device in accordance with the process of claim 9 wherein the step of manufacturing the set of indicia using an electrodeposition process includes the manufacturing of a set of indicia having information related to at least one of either a wedding, a social event, a religious event, a business event, a family event, or any general communication, piece of information, or graphic, any of which can be selected as necessary for a particular application.

11. The process of manufacturing an insignia device in accordance with process of claim 10 wherein the step of disposing the set of indicia onto the mounting surface includes the step of selecting a mounting surface material from the group consisting of paper, cardstock, plastic stock, wood stock, metal, leather, and any other type of material that is capable of allowing the set of indicia to be properly mounted onto the mounting surface material.

12. An insignia device comprising:
a set of indicia;
means for manufacturing the set of indicia using an electrodeposition process; and
means for mounting the set of indicia onto a mounting surface to make a communication device.

13. The insignia device of claim 12 wherein the mounting surface is selected from the group consisting of paper, cardstock, plastic stock, wood stock, metal, leather, and any other type of material that is capable of allowing the set of indicia to be properly mounted onto the mounting surface material.
